(19) United States
(12) Patent Application Publication
(10) Pub. No.: US 2023/0294854 A1
(43) Pub. Date: Sep. 21, 2023

(54) FLUID PRODUCT DISPENSING MECHANISM INTENDED FOR A PRODUCT DISPENSING MACHINE, AND ASSOCIATED MACHINE

(71) Applicant: CAPSUM, MARSEILLE (FR)

(72) Inventor: Yan eric PAFUMI, GARDANNE (FR)

(21) Appl. No.: 18/040,908

(22) PCT Filed: Aug. 10, 2021
(86) PCT No.: PCT/EP2021/072312

§ 371 Date: Feb. 7, 2023

(30) Foreign Application Priority Data
Aug. 11, 2020 (FR) FR2008422

(51) Int. Cl. B65B 3/12; B65B 3/28; B65B 43/59

(52) U.S. Cl. CPC B65B 3/12; B65B 3/28; B65B 43/59

(57) ABSTRACT

The mechanism comprises: a syringe comprising a syringe body, a piston comprising a piston head sealingly closing the syringe barrel, a rod and a gripping member carried by the rod; a movement actuator for moving the plunger in two opposing directions along the axis of movement of the piston in the syringe body, the movement actuator comprising a movement member and a locking device for locking the gripping member, capable of switching from an open configuration for receiving the gripping member to a closed configuration for immobilizing the gripping element in which the gripping member is secured in translation with the movement member in the two opposing movement directions.

This is a National Stage application of PCT international application PCT/EP2021/072312, filed on Aug. 10, 2021, which claims priority from French Patent Application No. 20 08422, filed on Aug. 11, 2020, both which are incorporated herein by reference in their entirety.

The present invention relates to a fluid product dispensing mechanism, intended for a product dispensing machine, comprising a dispensing nozzle.

The machine is e.g. a terminal for dispensing a product in a commercial space, intended for being used directly by a consumer. The machine is particularly suitable for a consumer who comes into the commercial space with an empty or extemporaneously cleaned packaging.

Machines for the bulk release of compositions, in particular cosmetic compositions, in stores, and which can be used directly by the consumer, have appeared for a few years and are meeting increasing success, in particular with regard to the economic, and especially ecological, interest thereof.

In the case of cosmetic compositions, such machines are suitable for the release of compositions which are generally simple and have low viscosity, where appropriate in the form of conventional emulsions.

The term “conventional emulsion” refers to a continuous phase, generally aqueous, and a dispersed phase which is not or only slightly miscible with the continuous phase, generally oily, in the form of microscopic drops, in particular with a mean diameter of less than 250 microns.

As an illustration, liquid bulk dispensing machines are proposed by 3J Development (3JD) or CoZie.

Such machines are suitable for containing compositions in relatively large volumes in order to satisfy demand and to avoid handling.

However, such machines have dispensing mechanisms unsuitable for compositions with high viscosities and/or compositions in the form of emulsions or dispersions with a dispersed phase in the form of macroscopic drops, in particular with an average diameter greater or equal to 250, Preferentially greater than or equal to 500 microns, or even greater than or equal to 750 microns.

Such compositions generally have to be handled with great care, for reliable dispensing without deterioration of the dispersed phases present in the composition.

A purpose of the invention is to obtain a product dispensing mechanism, in particular apt to release viscous compositions and/or compositions having macroscopic drops, which would be reliable in use, simple to maintain, in particular in a commercial space and which does not cause any significant deterioration of the dispensed composition.

To this end, the subject matter of the invention is a mechanism of the aforementioned type, characterized by:
a syringe comprising a syringe barrel intended for receiving the product, connected to the dispensing nozzle, and a plunger comprising a plunger head sealing the syringe barrel, a rod and a gripping element supported by the rod;
an actuator for moving the plunger in two opposite directions along the axis of movement of the plunger inside the syringe barrel, the movement actuator comprising a moving element and a locking device for the gripping element, suitable for switching from an open configuration for receiving the gripping element to a closed configuration for locking the gripping element wherein the gripping element is rigidly attached in translation with the moving element in the two opposite directions of movement.

The mechanism according to the invention can comprise one or a plurality of the following features, taken individually or according to any technically possible combination:
the locking device includes an end fitting and a lock mounted apt to rotate about an axis with respect to the end fitting, the lock comprising a cavity with a shape matching the gripping element;
the axis of rotation of the lock with respect to the end fitting is perpendicular to the axis of movement of the plunger inside the syringe barrel;
the lock defines a slot opening into the cavity, the rod being inserted into the slot in the closed configuration;
the locking device includes a locking actuator for the lock, suitable for moving the lock for switching the locking device from the open configuration to the closed configuration;
the locking device can be jointly moved with the moving element;
the gripping element is an element of revolution about the axis of movement, the gripping element preferentially being a sphere;
the locking device is suitable for being inserted at least partially into the syringe barrel;
a syringe barrel fastening system, the syringe barrel fastening system comprising a bayonet mount;
the system for fastening the syringe barrel includes a pin for locking the rotation of the syringe, suitable for cooperating with a protrusion on the syringe barrel, for locking the rotation;
the mechanism comprises a support device for a recipient intended for receiving the fluid product, the support device comprising a cup for receiving the recipient, placed opposite the nozzle, the cup being movable between a retracted position for placing the recipient, and an extended position where the recipient can move towards the nozzle;
the support device comprises a gage for measuring the weight applied to the cup, jointly movable with the cup;
the support device comprises a transmission rod for the weight applied to the cup, and a spring interposed between the transmission rod and the cup;
the product comprises at least one dispersed phase in a continuous phase, in particular the product is in the form of an emulsion comprising a dispersed phase in the form of macroscopic drops, in particular with a mean diameter greater than or equal to 250 micrometers, preferentially greater than or equal to 500 micrometers, or even greater than or equal to 750 microns;
the mechanism comprises a central control unit for the movement actuator, suitable for controlling the movement actuator so as to release at least a predetermined quantity of product by moving the plunger in the syringe barrel in a first direction, then optionally, at the end of the release of the or of each predetermined quantity of product, for moving the plunger in a second direction opposite to the first direction over a predetermined return stroke.

A further subject matter of the invention is a product dispensing machine including:
a casing;
a mechanism as defined above, arranged at least partially in the casing, the dispensing nozzle protruding out of the casing.

The invention will be better understood upon reading the following description, given only as an example and making reference to the enclosed drawings, wherein:

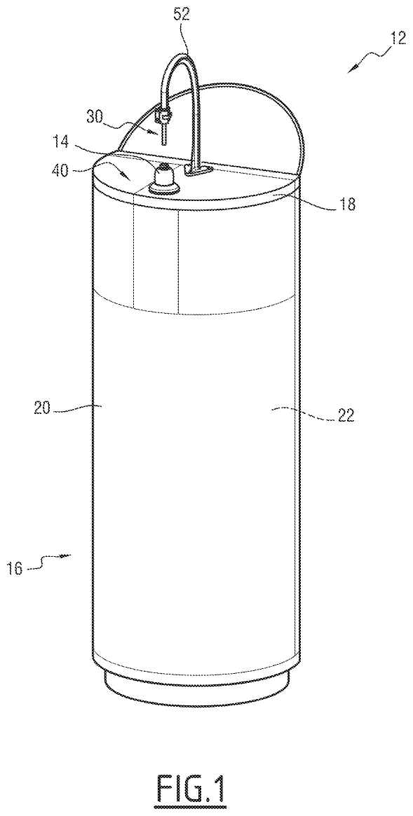

FIG. 1 is a three-quarter frontal perspective view of a first product dispensing machine equipped with a dispensing mechanism according to the invention;

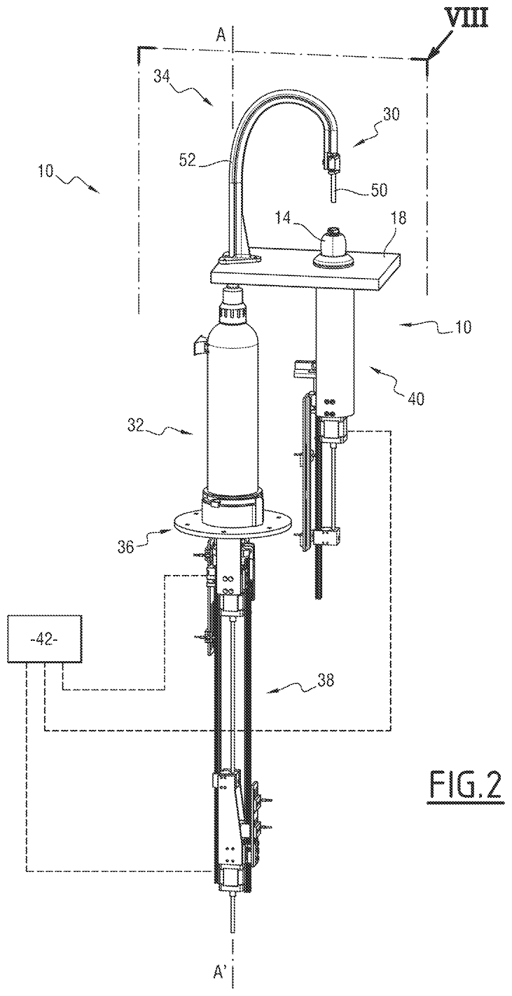

FIG. 2 is a view similar to FIG. 1 showing the product dispensing mechanism according to the invention;

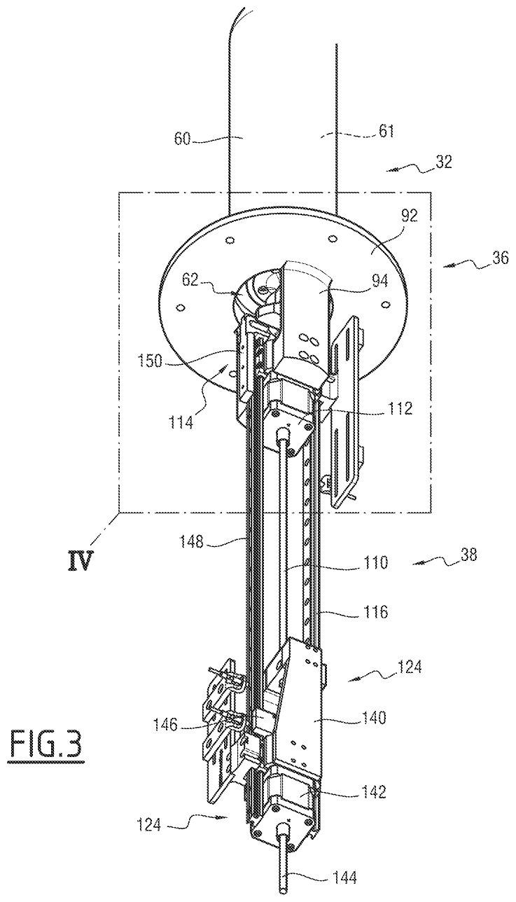

FIG. 3 is a detailed schematic view of the product dispensing mechanism;

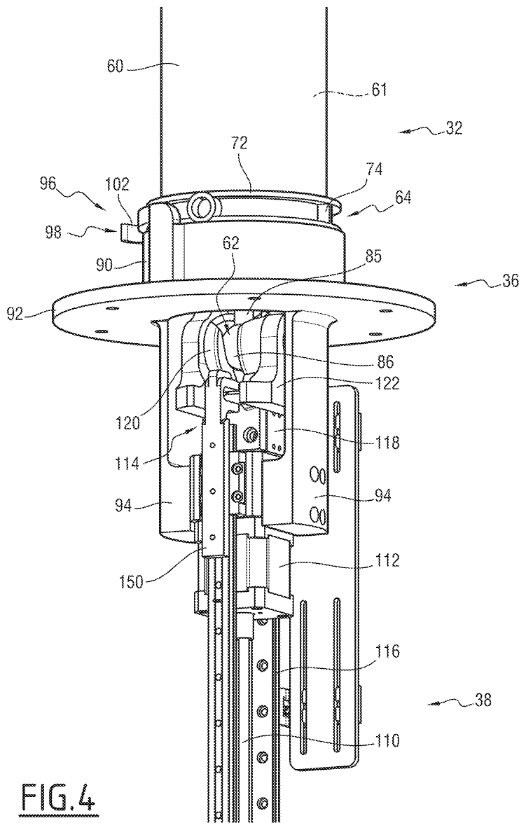

FIG. 4 is a view of the detail identified as IV in FIG. 3;

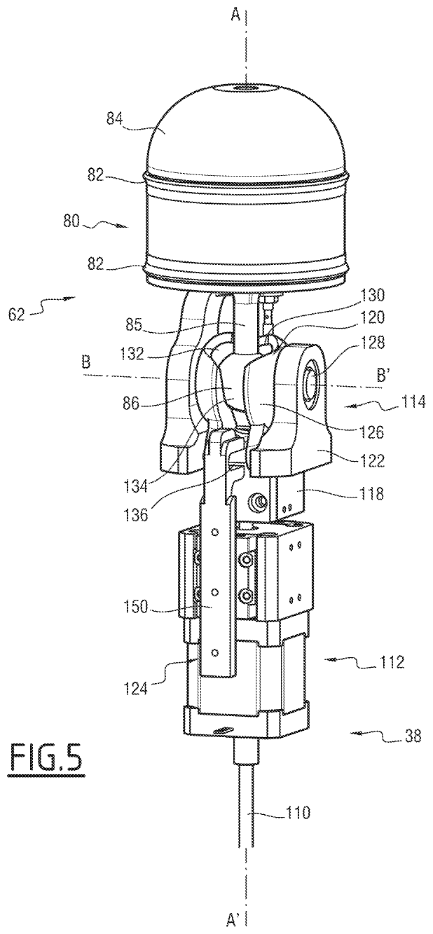

FIG. 5 is an enlarged view of FIG. 4, with only the relevant parts for illustrating the locking system of the mechanism;

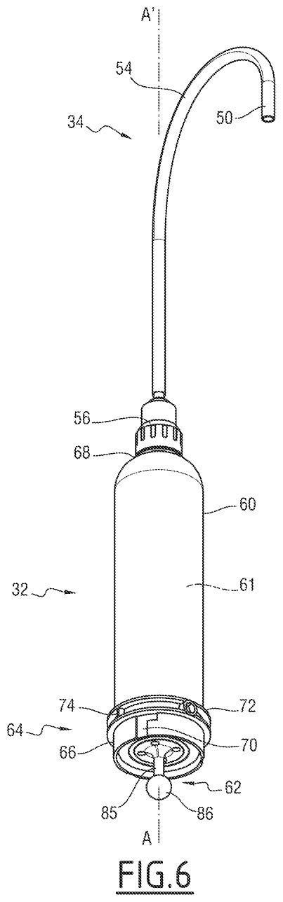

FIG. 6 is a view of a replaceable syringe for the dispensing mechanism shown in FIG. 2;

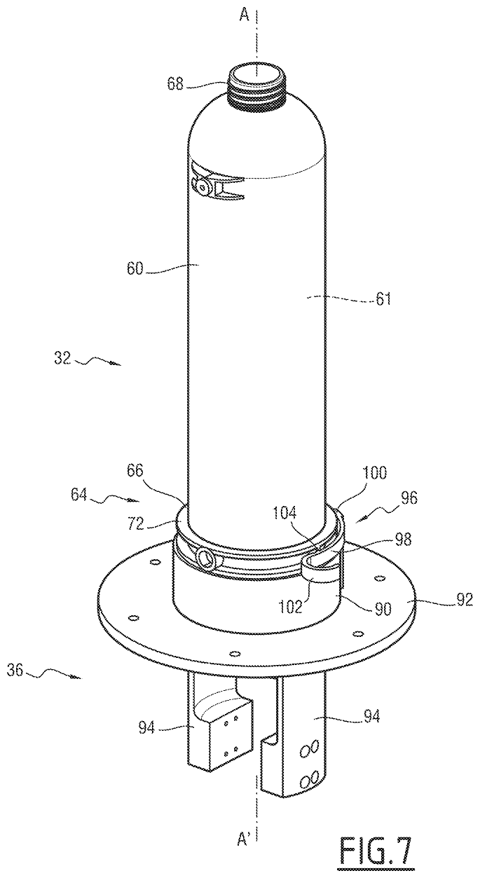

FIG. 7 is a view of the syringe barrel and of the support thereof;

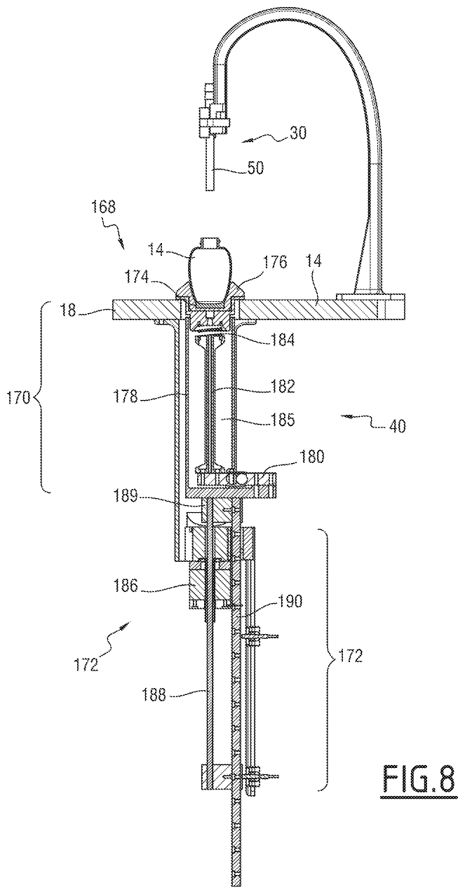

FIG. 8 is a view of a device for supporting a recipient wherein the product is released.

A first product dispensing mechanism 10 according to the invention is illustrated in FIG. 2. The mechanism 10 is intended for a product dispensing machine 12 visible in FIG. 1.

The product dispensed by the mechanism 10 is a fluid product, in particular a composition, more particularly a cosmetic composition.

The term “fluid product” refers to a product which, at ambient temperature and atmospheric pressure, is apt to flow under its own weight thereof, as opposed to a solid composition.

The viscosity of a fluid product or at least one of the phases thereof can vary significantly, which makes it possible to obtain varied textures. The viscosity is measured at ambient temperature and at ambient pressure according to the method described in WO2017046305.

According to one embodiment, a fluid product has a viscosity comprised from 1 MPa·s 25 to 500,000 MPa·s, preferentially from 10 MPa·s to 300,000 MPa·s, better still from 400 MPa·s to 100,000 MPa·s, and more particularly from 1000 MPa·s to 30,000 MPa·s, as measured at 25° C., according to the method described hereinabove.

The composition is advantageously in the form of a single or multiple emulsion comprising a continuous phase and a dispersed phase in the form of macroscopic drops, more particularly with a mean diameter greater than or equal to 250 microns, preferentially greater than or equal to 500 microns, or even greater than or equal to 750 microns.

Preferentially, the composition is in the form of a simple emulsion, more particularly oil-in-water or water-in-oil, and better oil-in-water. The dispersed phase and the continuous phase are advantageously immiscible with one another at ambient temperature (T=25° C.±2° C.) and atmospheric pressure (760 mm Hg, i.e. 1.013×10⁵ Pa or 10¹³ mbar). Thereby, the solubility at ambient temperature and at atmospheric pressure of the dispersed phase in the continuous phase is advantageously less than 5% by weight, and vice versa.

Within the context of the present invention, the aforementioned emulsions can be designated indifferently by the term “dispersions”.

Preferentially, the composition is a composition as described in WO2017046305 or in the French Patent Applications No. 2005408 and No. 2005410 filed on 21 May 2020.

With reference to FIG. 1, the product dispensing machine 12 is herein a terminal intended for being placed e.g. in a commercial space, in particular in a store. The terminal is accessible to a consumer of the product, in particular for filling a recipient 14 with product. The recipient 14 is e.g. a recipient brought by the consumer, or a recipient 14 supplied to the consumer by the sales space.

In the example illustrated in FIG. 1, the machine 12 comprises, in addition to the dispensing mechanism 10, an outer casing 16 partly containing the mechanism 10.

Herein, the outer casing 16 includes an upper plate 18 from which at least a part of the mechanism 10 protrudes out of the casing 16, and a peripheral wall 20.

The peripheral wall 20 delimits an internal volume 22 closed at the top by the upper plate 18. The internal volume 22 receives another part of the mechanism 10. The peripheral wall 20 preferentially delimits an access flap (not shown) to the internal volume 22, for the maintenance of the mechanism 10 and the replacement of the consumables.

With reference to FIG. 2, the dispensing mechanism 10 includes a dispensing nozzle 30, a replaceable syringe 32 and a tube 34 connecting the syringe 32 to the nozzle 30.

The mechanism 10 further comprises a syringe support 36, for the removable mounting of the syringe 32, and a movement actuator 38, suitable for dispensing the product from the syringe 32.

Advantageously, the mechanism 10 further comprises a motorized support device 40 for the recipient 14, and/or a central control unit 42 for controlling the mechanism 10.

In the example shown in FIG. 2, the dispensing nozzle 30 includes a rigid spout 50 which herein extends vertically. The rigid spout 50 here extends vertically and opens downwards.

The nozzle 30 further includes a curved arm 52 (see FIG. 1) which carries the tube 34 and the spout 50 above the upper plate 18. Advantageously, the curved arm 52 further comprises a system for holding the end of the tube 34 opposite the syringe 32 and/or the spout 50. Said holding system can be represented by a clip-on clamping ring.

Preferentially, the rigid spout 50 is provided with an advantageously cylindrical bulge, suitable for cooperating with the curved arm 52 which is then provided with a housing for receiving the bulge.

When the tube 34 is positioned within the curved arm 52, and the bulge of the rigid spout 50 is inserted into the housing thereof, the holding system can be activated, e.g. manually for holding the position and the orientation of the spout 50 with respect to the support device 40 for the recipient 14.

In a variant, the dispensing nozzle 30 has no rigid spout 50, the free end of the tube 34 being mounted in the holding system.

With reference to FIG. 6, the tube 34 is intended for connecting the syringe 32 to the nozzle 30. The tube comprises a flexible conduit 54, intended for extending over or under the curved arm 52, preferentially over the curved arm 52, and optionally a stop valve 56 suitable for being handled from a closed configuration of the syringe 32, during the storage and the transport of the syringe, to an open configuration of use.

The stop valve 56 can be actuated e.g. by rotation about an axis coaxial with the axis A-A′ of the syringe 32.

In a variant, a plug is placed on the spout 50 or on the free end of the tube 34 for replacing the stop valve 56.

The syringe 32 is intended for containing, in a leak-tight manner, the product dispensed by the mechanism 10. With reference to FIGS. 4 to 6, the syringe includes a syringe barrel 60 defining an internal volume 61 containing the product, a plunger 62 mounted apt to move within the syringe barrel 60 for closing the internal volume 61, and a mechanism 64 for fastening to the support.

Throughout hereinafter, the syringe 32 is illustrated as mounted with a vertical syringe axis A-A′, corresponding to the axis of movement of the plunger 62, the plunger 62 closing the syringe 32 at the bottom. The terms used, in particular the terms “top”, “bottom”, “upper”, “lower”, are thus with regard to the above orientation. Other orientations of the syringe 32 are conceivable, in particular inclined, horizontal or head down.

Moreover, the terms “upstream” and “downstream” are understood with respect to the normal direction of distribution of the product outside the mechanism 10.

The syringe barrel 60 is herein substantially cylindrical about the axis A-A′. The syringe barrel has a base 66 open upstream and a syringe head 68 downstream. The valve 56 of the tube 34 is fastened to the syringe head 68.

The internal volume 61 is delimited in a leak-tight manner by the syringe barrel 60. The internal volume opens downstream through the head 68 and upstream through the base 66.

The syringe barrel 60 is easy to handle and has a moderate weight. The syringe barrel is removable and cleanable. Preferentially, the syringe barrel is made of a transparent or translucent material.

Examples of material are metal (e.g. stainless steel) or plastic (e.g. polyolefin such as polyethylene).

Preferentially, the internal volume 61 is greater than or equal to 500 ml, better still greater than or equal to 1 liter, and more particularly greater than or equal to 1.5 liter.

The fastening mechanism 64 includes a notch 70 with the shape of an inverted L, a peripheral collar 72, and at least one protrusion 74 for locking the rotation.

As will be seen below, the notch 70 is intended for receiving a stop of the syringe support 36 so as to form a bayonet mount. The notch has an axial portion for inserting the stop opening upstream along the axis A-A′, and a peripheral portion for locking the stop extending around the axis A-A′.

In the present example, the fastening mechanism 64 includes several locking protrusions 74. The protrusions 74 are formed in the collar 72 for cooperating with a lug of the syringe support 36 and for preventing the syringe 32 from rotating inside the syringe support 36, as will be seen hereinbelow.

With reference to FIGS. 5 and 6, the plunger 62 includes a plunger head 80, at least one peripheral seal 82 mounted on the plunger head 80, a plunger rod 85 protruding upstream from the plunger head 80, and a gripping element 86, intended for cooperating with the movement actuator 38.

In the present example, the plunger head 80 has a hemispherical downstream surface 84. The downstream surface 84 closes the volume 61 upstream inside the syringe barrel 60, so as to maintain the product within the internal volume 61 in a leak-tight manner, during the storage or the dispensing thereof. In the present example, the plunger 62 includes two seals 82 extending circumferentially about the axis A-A′, being spaced apart from each other along the axis A-A′.

The presence of at least two seals 82, spaced apart by a suitable distance, provides the coaxiality of the movement of the plunger 62 with the axis A-A′, and thus provides a better control over the volumes of product dispensed. Such is particularly the case when the seals 82 are lip seals.

The rod 85 herein protrudes upstream from the plunger head 80. The rod is advantageously coaxial with the axis A-A′.

The gripping element 86 is arranged at the upstream free end of the rod 85. In the present example, the gripping element 86 is an element of revolution about the axis of the rod 85, and advantageously of the axis A-A′.

Preferentially, the gripping element 86 is a sphere.

The plunger 62 can move in translation along the axis A-A′ inside the syringe barrel 60 in both directions of movement along the axis A-A′. In the downstream direction (upwards in the figures), the plunger being apt to push the product out of the internal volume 61 of the syringe barrel 60, so as to release the product down to the dispensing nozzle 30 through the tube 34.

In the opposite direction, directed upstream (downwards in the figures), the plunger 62 is apt to suck up the product contained in the nozzle 30, so as to prevent a drop of residual drops of product at the nozzle 30, outside the operations of dispensing a product into the recipient 14. Such suction of the product is preferentially limited to the residual drop at the end of the spout 50, not heavy enough to detach by itself

Advantageously, the syringe 32 and the tube 34 provided at the end thereof with the rigid spout 50, form a consumable which can be replaced, when the product contained in the internal volume 61 of the syringe barrel 60 is exhausted, or when another product has to be released, in replacement of the product contained in the syringe 32.

As can be seen in FIG. 7, the syringe support 36 includes a cylindrical peripheral skirt 90, intended for receiving and supporting the base 66 of the syringe barrel 60, a fastening flange 92, extending radially at the periphery of the skirt 90, and the support tabs 94 of the movement actuator 38.

The syringe support 36 further includes a matching support mechanism 96 for fastening the syringe barrel 60.

The skirt 90 has a shape matching to the base 66 of the syringe barrel 60. Same is suitable for receiving the base 66 with the collar 72 resting on the downstream edge of the skirt 90.

The flange 92 extends radially with respect to the axis A-A′ outside the skirt 90. The flange is intended for being fastened to a frame of the machine 12.

The tabs 94 project axially from the flange 92, opposite the skirt 90. The tabs delimit therebetween an intermediate space for receiving the movement actuator 38.

In the present example, the matching mechanism 96 includes a stop (not visible) inserted in the skirt 90, apt to cooperate with the notch 70 so as to form the bayonet mount. In the present example, the matching mechanism further includes a circumferential lug 98, protruding above the downstream edge of the skirt 90, extending over part of a circumference around the axis A-A′.

The lug 98 includes an end 100 fastened to the skirt 90, a folded free end 102 suitable for being gripped by a user, and an internal stop 104 protruding towards the axis A-A′, suitable for cooperating with the protrusion 74 of the fastening mechanism 64 on the collar 72.

Thereby, the syringe barrel 60 is suitable for being inserted into the skirt 90, by placing the or each internal stop in a notch 70, so as to move the syringe barrel 60 in translation along the axis A-A′ towards the support 36.

The syringe barrel 60 is then apt to pivot about the axis A-A′ so as to move the or each internal stop into the circumferential region of the notch 70 and to lock the rotation of the syringe barrel 60 about the axis A-A′, by cooperation between the protrusion 74 and the internal stop 104 of the lug 98.

The syringe barrel 60 is thereby fastened in a reproducible and robust manner in the support 36, without any difficulty for the user.

In such configuration, when the plunger 62 is situated in the vicinity of the base 66 of the syringe, the rod 85 and the gripping element 86 protrude axially upstream under the flange 92, between the tabs 94.

With reference to FIGS. 3, 4 and 5, the movement actuator 38 includes a moving element 110 for moving the plunger 62, movable in translation along the axis A-A′, a motor 112 for moving the moving element 110, and a device 114 for locking the plunger 62 which in the present example is movable by the moving element 110.

The movement actuator 38 further comprises at least one guide rail 116 for the movement of the locking device 114, extending parallel to the axis A-A′.

The movement motor 112 is mounted fixed with regard to the syringe support 36. Herein, the movement motor is mounted between the tabs 94 of the syringe support 36.

The moving element 110 is translated along the axis A-A′ by the motor 112. The moving element is provided at the upper end thereof with a block 118 (visible in particular in FIG. 5) for supporting the locking device 114. The moving element 110 has a length greater than or equal to the stroke of the plunger 62 inside the syringe barrel 60.

With reference to FIG. 5, the locking device 114 includes a movable lock 120, an end fitting 122, a support for the movable lock 120 and a locking actuator 124. Advantageously, the movable lock 120, the end fitting 122 supporting the movable lock 120 and the locking actuator 124 are jointly movable with the moving element 110.

The movable lock 120 is apt to grip the gripping element 86 and then to lock same, so as to rigidly attach the gripping element 86 in translation in both directions along the axis A-A′ and, more generally, the plunger 62 with respect to the moving element 110.

In the present example, the lock 120 includes a cradle 126 mounted apt to rotate about an axis B-B′ perpendicular to the axis A-A′ and pins 128 protruding from the cradle 126 along the axis B-B′.

The cradle 126 delimits an internal cavity 130 the shape of which is at least partially matching the shape of the gripping element 86. The cavity 130 opens out through an opening 132 for inserting the gripping element 86 into the cavity 130, which is extended laterally by a slot 134 for receiving the rod 85.

The insertion opening 132 is configured for inserting the gripping element 86 by translation along the axis A-A′. On the other hand, the slot 134 has a width greater than the width of the rod 85, but smaller than the width of the gripping element 86, so as to prevent the gripping element 86 from coming out of the internal cavity 130.

The lock 120 is mounted apt to rotate about the axis B-B′ with respect to the end fitting 122 between an open configuration for receiving the gripping element 86, wherein the cavity 132 opens downstream (upwards in FIG. 5) for receiving the gripping element 86 and a closed locking configuration of the gripping element 86, wherein the cavity 132 has been pivoted by at least 30°, and the slot 134 opens downstream for locking the gripping element 86 within the cavity 130.

The lock 120 further comprises a maneuvering bar 136, suitable for being gripped by the locking actuator 124, for maneuvering the lock 120 between the open configuration and the closed configuration.

With reference to FIG. 3, the locking actuator 124 includes a stirrup 140, rigidly attached to an upstream end of the moving element 110, a locking motor 142 mounted on the stirrup 140, a drive rod 144 translated parallel to the axis A-A′ by the locking motor 142, and a element 146 driven by the rod 144. Same further includes a drive rail 148 controlled by the driven element 146 and a fork 150 for maneuvering the lock 120, mounted rigidly attached to the downstream end of the drive rail 148.

The stirrup 140 is fastened on the moving element 110 so as to be jointly movable with the moving element 110. Same is mounted apt to slide on the guide rail 116.

The locking motor 142 can be actuated independently of the movement motor 112.

The rod 144 is suitable for moving the driven element 146 in translation parallel to the axis A-A′ with respect to the stirrup 140 and to the locking motor 142.

The drive rail 148 extends laterally with respect to the driven element 146. The downstream end thereof is arranged axially facing the lock 120.

The fork 150 is mounted rigidly attached to the drive rail 148 at the downstream end thereof. Same is engaged on the lock 120, advantageously by gripping the maneuvering bar 136.

Thus, the fork 150 is axially movable parallel to the axis A-A′ by actuating the motor 142, generating the joint axial movement of the rod 144, of the driven element 146 and of the drive rail 148, for switching over the lock 120 between the open configuration thereof and the closed configuration thereof.

The presence of two independently controlled motors 112, 142, the locking motor 142 being jointly movable with the lock 120, simplifies the control of the motors 112, 142, with no need to synchronize the movements thereof.

The locking motor 142 can thereby be controlled by the central control unit 42 independently of the movement motor 112. Same advantageously remains inactive during an actuation of the movement motor 112 intended to displace the plunger 62.

Furthermore, the locking device 114 is particularly compact transversely to the axis A-A′. The assembly formed by the lock 120, the support end fitting 122, the support block 118, and the fork 150 is thereby apt for being inserted into the syringe barrel 60 during the downstream movement of the plunger 62 towards the syringe head 68, imparting a long stroke to the plunger 62 in the syringe barrel 60.

With reference to FIG. 8, the support device 40 of the recipient 14 includes a movable support system 170 of the recipient 14 and an actuator 172 for moving the movable system 170.

The movable system 170 includes a cup 174 intended for carrying the recipient 14 and advantageously, an adapter 176 intended for adapting to the recipient 14, for holding same inside the cup 174.

The movable system 170 further includes a movable sleeve 178, a force gage 180 intended for measuring the weight applied to the cup 174, partially received in the movable sleeve 178 and a movable force transmission rod 182 protruding into the movable sleeve 178 from the force gage 180.

Advantageously, the movable system 170 further includes a damper spring 184 interposed between the upper end of the movable rod 182 and the cup 174.

The cup 174 protrudes above the plate 18. The cup is suitable for receiving the adapter 176 which has a shape matching the shape of the recipient 14.

The sleeve 178 is inserted through a hole provided in the plate 18. The sleeve delimits an internal volume 185 receiving at least part of the force gage 180, the movable rod 182 and the spring 184.

The sleeve 178 is a structural part of the movable system 170 which hides the lower part of the movable system 170 for aesthetic reasons and to avoid allowing dust to fall into the support device 40.

Furthermore, the sleeve 178 receives the bearing force of the cup 174 possibly overloaded on the force gage 180 when the spring 184 is compressed. Advantageously, the sleeve 178 also prevents the support device 40 from being torn off.

The movable movement system 170 can thereby move vertically in an up-and-down movement for carrying the recipient 14 towards the dispensing nozzle 30, from a lower position of fitting the recipient 14 in the cup 174 (visible in FIG. 8), wherein the nozzle 30 is located above and away from the recipient 14, towards an upper position wherein the nozzle 30 is received at least partially within the recipient 14 during dispensing of the product.

According to a first variant, the movable movement system 170 can again be moved into the lower position, once the product has been dispensed. According to a second variant, the movable movement system 170 moves into the lower position as the recipient 14 is filled with product. The latter variant prevents the presence of air bubbles in the recipient 14.

The gage 180 is suitable for measuring the weight applied to the cup 174 under the effect of the weight of the recipient 14 and of the product inserted into the recipient 14.

The spring 184 is apt to transmit the weight applied on the cup 174 to the movable rod 182. In the event of an untimely pressing on the recipient 14, the spring 184 is apt to compress so as to prevent the transmission of too great a force to the force gage 180, the cup 174 then resting on the upper edge of the sleeve 178.

Advantageously, the force gage 180 is coupled to the central control unit 42 for further improved control of the quantity of product released into the recipient 14.

The actuator 172 has a structure similar to the movement actuator 38 described above. Same has a movement motor 186, a moving element 188, actuated by the motor 186, and a support block 189 carrying the sleeve 178, the force gage 180, and more generally the movable movement system 170. Same further includes a lateral guide rail 190.

The central control unit 42 includes a user interface suitable for identifying the preferences of the user with regard to dispensing the product and for adapting the quantity of product dispensed according to the preferences of the user and optionally to the volume of the recipient 14, then to the volume of product released detected by the force gage 180.

The central control unit 42 is apt to control the movement actuator 38 for releasing the quantity of product chosen, out from the internal volume 61 of the syringe 32, and advantageously, once the dispensing is finished, to retract the plunger 62 so as to prevent residual drops of product from dropping from the dispensing nozzle 30 outside the operations of dispensing a product into the recipient 14.

The central control unit 42 is also apt to control the locking actuator 124 for switching over the lock 122 between the open configuration and the closed configuration, when the syringe 32 is installed or removed.

Advantageously, the central control unit 42 is also apt to control the actuator 172 of the movable system 170 for moving the recipient 14, so as to mount the recipient 14 towards the nozzle 30 before dispensing the product, and to lower the recipient 14 away from the nozzle 30 after the product has been dispensed.

Advantageously, the central control unit 42 is further apt to control the movement actuator 38 according to the weight, and hence the volume, of the recipient 14 recognized by the force gage 180 which is as such coupled to the central control unit 42.

The weight detection on the force gage 180 has a safety role as well, allowing the control of the movement actuator 38 to be switched off if a collision is detected.

Moreover, the weight detection advantageously makes it possible to correct the release of the product in real-time (e.g. following the presence of bubbles, or the variation of the bore of the syringe).

The central control unit 42 includes e.g. at least one processor and at least one memory (not shown) containing software modules suitable for being executed by the processor for performing the aforementioned functions. Same preferentially includes a communication module for wireless control of the machine 12.

A method for dispensing product into a recipient 14 by means of the dispensing machine 12 will now be described.

Prior to dispensing product, the syringe 32 with the internal volume 61 filled with product, is loaded into the machine 12.

To this end, the lock 120 of the locking device 114 initially occupies the open configuration thereof. The introduction opening 130 is positioned along the axis A-A′ while being directed downstream (upwards in the figures).

The locking device 114 is retracted under the syringe support 36, preferentially in the utmost upstream position thereof.

A refillable assembly comprising the syringe 32, the tube 34, and the rigid spout 50 is provided, and is inserted into the dispensing mechanism 10.

The syringe barrel 60 is mounted longitudinally in the skirt 90 of the syringe support 60, so as to engage each internal stop (not visible) into the first axial region of a notch 70 with the shape of an inverted L. The syringe barrel 60 is then pivoted about the axis A-A′ so as to engage the internal stop in the second region of the inverted L-shaped notch.

Simultaneously, the lug 98 reaches the protrusion 74 located on the periphery of the syringe barrel 60, and engages into the protrusion 74 so as to prevent the syringe barrel 60 from rotating.

The collar 72 rests on the downstream edge of the skirt 90.

The gripping element 86 then protrudes along the axis A-A′ upstream, opposite the skirt 90 with respect to the flange 92.

The tube 34 is then placed along the curved arm 52, and the rigid spout 50 is immobilized vertically, in particular by means of a retaining device such as a clip-on clamping ring.

The locking device 114 is then moved downstream along the axis A-A′ by the movement actuator 38.

To this end, the movement motor 112 is controlled by the central control unit 42 for jointly moving the moving element 110, the support block 118, the end fitting 122 and the lock 120 in the open configuration thereof towards the gripping element 86 of the plunger 62.

In the machine shown in FIG. 2, the raising of the lock 120 and of the end fitting 122 take place jointly with the raising of the locking actuator 124, more particularly with the raising of the stirrup 140, of the motor 142, of the drive rod 144, of the driven element 146, of the drive rail 148 and of the fork 150.

When the gripping element 86 abuts the bottom of the cavity 130 of the cradle 126, the movement actuator 38 is stopped.

The movement actuator 38 is stopped e.g. when a metal part e.g. a metal ring, is detected by a sensor.

The locking actuator 124 is then activated for moving the drive rail 148 and the fork 150 and thereby pivoting the lock 120 about the axis B-B′. The lock 120 switches from the open configuration thereof to the closed configuration, wherein the rod 85 of the plunger 62 is engaged in the slot 134 provided in the lock 120.

The translation of gripping element 86 is then locked in both directions along the axis A-A′, by the lock 120. The gripping element 86 is apt to jointly move with the locking device 114 under the effect of the moving element 110 along the axis A-A′, in both directions of movement.

The machine 12 is then made available to the consumer. The consumer places a recipient 14 on the cup 174, advantageously using the adapter 176 adapted to the recipient 14. The movable movement system 170 maintains the cup 174 in the lower position thereof, away from the nozzle 30.

The consumer then chooses the amount of product that the consumer wishes to introduce into the recipient 14, e.g. by means of a human-machine interface of the central control unit 42.

In a variant, such determination is automatic, e.g. by measuring the weight of the recipient 14, and by inferring the capacity of the recipient from a database. In such case, the consumer will only be able to initiate the filling of the recipient 14, without choosing the amount.

The consumer then validates the start of product dispensing, advantageously using the human-machine interface.

The central control unit 42 controls the actuator 172 of the movable movement system 170 for lifting the cup 174 carrying the recipient 14 and bringing same into the upper position thereof towards the nozzle 30. The nozzle 30 is then advantageously partially inserted into the recipient 14.

The motor 186 of the actuator 172 generates the joint upward movement of the sleeve 178, of the gage 180, of the movable rod 182, of the spring 184 and of the cup 174.

A measurement of the weight applied to the gage 180 is then carried out, in order to obtain a tare value for dispensing the amount of the product.

When the central control unit 42 detects that the movable movement system 170 is in the upper position thereof, the dispensing of product is then activated.

For dispensing the amount of the product, the movement actuator 38 is activated for moving the plunger 62 over a volume corresponding to the desired volume of product to be dispensed into the recipient 14.

The movement motor 112 drives the moving element 110, which jointly moves downstream, the support block 118, the locking device 114, and the gripping element 86 rigidly attached to the locking device 114.

The plunger 62 then moves in the syringe barrel 60 downstream, so as to push the product to be released towards the syringe head 68.

Given the radial compactness of the locking device 114, the latter is also inserted into the syringe barrel 60 during the downstream stroke of the plunger 62.

Advantageously, the weight of product released into the recipient 14 is also measured by the gage 180, so that the central control unit 42 actuates the movement motor 112 until the selected weight of product is received into the recipient 14.

Preferentially, to prevent the fall of residual drops from the nozzle 30 outside the operations of dispensing a product into the recipient 14, and in particular at the end of dispensing, the movement motor 112 is activated for moving the moving element 110 upstream, over a limited stroke.

The support block 118 follows the moving element 110 upstream, driving the joint movement of the locking device 114, and of the gripping element 86, and of the plunger head 80, producing suction towards the internal volume 61.

A plurality of successive dispensing operations of product can then be carried out from the product contained in the volume 61.

When the quantity of product contained in the volume 61 is less than a given threshold, or when another product has to be released by the machine 12, the assembly consisting of the syringe 32, the tube 34 and the rigid spout 50 is then disassembled.

To this end, the lock 120 of the locking device 114 is returned to the open configuration thereof by activating the locking actuator 124.

The movement actuator 38 is then activated again to move the moving element 110 and the locking device 114 upstream (downwards in the figures), for detaching the locking device 114 from the gripping element 86 and extracting, where appropriate, the locking device 114 from the syringe barrel 60.

The lug 98 of the syringe support 36 is then released from the protrusion 74, e.g. by moving the lug radially outwards. The syringe barrel 60 is extracted from the syringe support 36, by pivoting the barrel about the axis A-A′, then by translating same away from the syringe support 36 along the axis A-A′.

The operations described hereinabove are then reproduced for loading another syringe 32 into the machine.

The dispensing mechanism 10 is thus particularly effective for enabling the machine 12 to be used directly by a consumer, in order to obtain precise amounts of product in a recipient 14, more particularly when the product is in the form of an emulsion provided with a dispersed phase in the form of macroscopic drops, more particularly with mean diameters greater than 250 microns and/or when the product is fragile.

Unlike mechanisms using a peristaltic pump, the dispensing mechanism 10 does not alter the macroscopic bubbles of the dispersed phase.

Alternatively, all the steps performed by the consumer can be performed by a seller or an in-store operator.

Dispensing using a syringe closed by a plunger generates little mechanical stress, more particularly shear stress, on the product, which keeps the product stable, even if the product is fragile.

Furthermore, the measured quantity is very precise and reproducible, even if the internal volume 61 of the syringe barrel 60 is large, which generally allows a plurality of successive dosing operations to be performed, without having to replace the syringe 32.

The machine 12 is thus particularly suitable for being used in sales spaces. The syringe 32 is easy to mount in the mechanism 10, which facilitates the maintenance of the machine 12 and the reloading thereof.

Furthermore, the mounting of the syringe 32 is particularly safe, more particularly due to the presence of the mechanism 64 for fastening the support 36 onto the syringe barrel 60 and of the matching mechanism 96 on the syringe support 36.

Once mounted, the syringe 32 remains immobilized on the support 36 thereof in an indexed position, which enhances the precision of the dispensing.

Since the syringe is pre-equipped with the plunger 62 thereof, with a gripping element 86, the product is confined in the internal volume 61, without any risk of contamination. Moreover, the locking of the gripping element 86 of the plunger 62 with the movement actuator 38 is simple and reliable in both directions of movement of the plunger 62 in the syringe 32, due to the use of the locking device 114 comprising a pivoting lock 120 mounted on a movable end fitting 122.

The insertion of the support element 86, having a symmetry of revolution about the axis A-A′, into the lock 120, is facilitated and can be carried out whatever the relative angular orientation of the plunger 62 with respect to the syringe barrel 60, and/or whatever the position of the support element 86 along the axis A-A′.

The locking as such is particularly stable, due to the gripping by the lock 120 in the slot 134 of the plunger rod 85, providing a secure locking of the gripping element 86 in both directions along the axis A-A′.

In this way it is possible not only to release the product with a very precise amount along a first direction of movement, but, if appropriate, to exert a limited suction once the dispensing has been carried out, so as to prevent the formation of residual drops from the nozzle 30 outside the operations of dispensing a product into the recipient 14.

Furthermore, the locking device 114 is very compact and apt to enter the volume 61 of the syringe barrel when the product is released. The overall volume and height of the mechanism 10 in this way is reduced, and has a direct impact on the volume occupied in the commercial space, and on the aesthetics of the machine 12.

The optional presence of a movable system 170 for moving the recipient 14, associated with a movement actuator 172 provides a “rise-and-fall” movement for the recipient 14.

Due to the movable system 170, the filling of the recipient 14 is optimized, without any risk of leaks, since the nozzle 30 is inserted into the recipient 14 during the dispensing of the product.

On the other hand, access to the recipient 14 remains simplified for the user, with regard to placing the recipient 14 on the movable system 170, and to removing the recipient 14 filled with product, once the dispensing has been carried out.

Furthermore, the presence of a force gage 180 adapts the volume dispensed to the recipient 14 and prevents overflows. Furthermore, the central control unit 42 of the mechanism 10 provides precise and reliable control of the dispensing.

In a variant, the lug 98 for locking the protrusion 74 is replaced by a clamping ring system (not shown), which encircles the syringe barrel 60 at the base 66 thereof. The clamping ring can be activated by rotation. It is no longer necessary to index the syringe barrel 60 on the syringe support 36.

In another variant, the lock 120 of the locking device 114 is apt to be actuated manually by the user. The mechanism then has no locking actuator 124.

In yet another variant, the locking actuator 124 is not embedded on the moving assembly of the movement actuator 38 comprising the moving element 110 and the support block 118.

The locking motor 142 is then controlled by synchronizing same with the movement motor 112 so as to choose the configuration of the lock 120 between the opening configuration and the closing configuration.

Advantageously, the machine 12 further comprises a cleaning/sterilizing device (not shown) for washing/sterilizing the recipients 14 extemporaneously before the filling thereof with the product, so as to prevent any risk of contamination if the consumer has not properly washed the primary packaging thereof and/or so as to comply with the regulatory standards and rules in force. The cleaning device is preferentially anhydrous (there is not always a water point in the store). Preferentially, same is based on a cleaning/sterilization method based on UV and/or pulsed light, or on ozone sterilization.

Advantageously, the syringe support 36, in particular the skirt 90, comprises a sensor making it possible to make sure that the syringe 32 is properly fastened to the syringe support 36.

The mechanism 10 according to the invention comprising a locking device 114 as described hereinabove is also advantageous in the event of a power cut. In such case, the position of the plunger 62 can be sought for readjustment by a simple operation comprising the steps of:
unlocking the plunger 62 with respect to the locking device 114,
moving the locking device 114 upstream for finding an end of stroke,
raising of the locking device 114 towards the plunger 62, following the position of the locking device 114, then
re-locking the locking device 114 on the plunger 62.

1. A fluid product dispensing mechanism for a product dispensing machine , the mechanism comprising:
a dispensing nozzle;
wherein the mechanism comprises:
a syringe comprising a syringe barrel intended for receiving the product, connected to the dispensing nozzle, and a plunger comprising a plunger head sealing the syringe barrel, a rod and a gripping element supported by the rod;
an actuator for moving the plunger in two opposite directions along the axis of movement of the plunger inside the syringe barrel, the movement actuator comprising a moving element and a locking device for the gripping element, apt to switch over from an open configuration for receiving the gripping element to a closed configuration for locking the gripping element wherein the gripping element is rigidly attached in translation to the moving element in the two opposite directions of movement.

2. The mechanism according to claim 1, wherein the locking device includes end fitting and a lock mounted apt to rotate about an axis with respect to the end fitting, the lock including a cavity with a shape matching the gripping element.

3. The mechanism according to claim 2, wherein the axis of rotation of the lock relative to the end fitting is perpendicular to the axis of movement of the plunger inside the syringe barrel.

4. The mechanism (10) according to claim 2, wherein the lock defines a slot opening into the cavity, the rod being inserted into the slot in the closed configuration. cm 5. The mechanism according to any of claim 2, wherein the locking device includes a locking actuator for locking the lock, apt to move the lock for switching over the locking device from the open configuration to the closed configuration.

6. The mechanism according to claim 2, wherein the locking device is jointly movable with the moving element.

7. The mechanism according to claim 1, wherein the gripping element is an element of revolution about the axis of movement, the gripping element preferentially being a sphere.

8. The mechanism according to claim 1, wherein the locking device is suitable for being at least partially inserted into the syringe barrel.

9. The mechanism according to claim 1, including a fastening device for the syringe barrel, the fastening device for the syringe barrel including a bayonet mount.

10. The mechanism according to claim 9, wherein the device for fastening the syringe barrel includes a pin for locking the rotation of the syringe, suitable for cooperating with a protrusion so as to lock the rotation, on the syringe barrel.

11. The mechanism according to claim 1, including a support device for a recipient intended for receiving the fluid product, the support device including a cup for receiving the recipient, placed opposite the nozzle, the cup being movable between a retracted position for fitting in the recipient, and an extended position for moving the recipient towards the nozzle.

12. The mechanism according to claim 11, wherein the support device comprises a gage for measuring the weight applied to the cup, jointly movable with the cup.

13. The mechanism according to any of claim 11, wherein the support device comprises a transmission rods for the weight applied to the cup, and a spring interposed between the transmission rod and the cup.

14. The mechanism according to claim 1, wherein the product comprises at least one dispersed phase in a continuous phase, in particular the product is in the form of an emulsion comprising a dispersed phase in the form of macroscopic drops, in particular of an average diameter greater than or equal to 250 micrometers, preferentially greater than or equal to 500 micrometers, or even greater than or equal to 750 micrometers.

15. The mechanism according to claim 1, comprising a central unit for controlling the movement actuator, apt to control the movement actuator so as to release at least a predetermined quantity of product by moving the plunger inside the syringe barrel in a first direction, then optionally, at the end of release of the or of each predetermined quantity of product, to move the plunger in a second direction opposite to the first direction over a predetermined return stroke.

16. A product dispensing machine including:
a casing;
a mechanism according to claim 1, arranged at least partially inside the casing, the dispensing nozzle protruding out of the casing.
